(19) United States
(12) Patent Application Publication
(10) Pub. No.: US 2020/0240609 A1
(43) Pub. Date: Jul. 30, 2020

(54) VEHICLE LIGHTING DEVICE WITH A DIGITAL MICROMIRROR DEVICE

(71) Applicant: Varroc Lighting Systems, s.r.o., Senov u Noveho Jicina (CZ)

(72) Inventors: Jan KRATOCHVIL, Trebic (CZ); Jan GALIA, Stary Jicin (CZ)

(21) Appl. No.: 16/775,329

(22) Filed: Jan. 29, 2020

(30) Foreign Application Priority Data
Jan. 30, 2019 (CZ) PV 2019-48

(51) Int. Cl. F21S 41/675; F21S 41/36; F21S 41/125; F21S 41/40

(52) U.S. Cl. CPC F21S 41/675; F21S 41/40; F21S 41/125; F21S 41/36

(57) ABSTRACT

A vehicle lighting device which includes a digital micromirror device (DMD) connected to a control device. At least two sources of radiation with differently colored output lights are directed to the active reflective surface of the DMD formed by the micromirrors and in front of the active reflective surface of the DMD an output element of the vehicle lighting device is situated. The control device of the DMD is designed to independently control the position of the individual micromirrors of the DMD. The first light source includes at least one independently controllable white light source and the second light source includes at least one independently controllable non-white light source. The DMD control device is adapted to control the micromirrors of the DMD to project white light through the output element and simultaneously independently control part of the micromirrors of the DMD to independently project at least one non-white light pattern through the output element of the vehicle lighting device.

### TECHNICAL FIELD

The invention relates to a vehicle lighting device which comprises a digital micromirror device (DMD) connected to a control device, whereby at least two mutually separate light sources with differently colored output beams are directed at the active reflecting surface of the DMD formed by the micromirrors, and an output element of the vehicle is situated in front of the active reflective surface of the DMD in the direction of the radiation reflection from the active reflective surface; wherein the DMD control device is adapted to independently control the position of the individual DMD micromirrors.

### BACKGROUND ART

Digital micromirror devices, hereinafter referred to as “DMDs” (digital micromirror device), are known per se, especially in the field of image projectors. The light emitted by a light source is projected onto the DMD active surface, from which it is reflected in the desired direction by controlled tilting of each micromirror in the active surface which, when tilted to the appropriate position, either reflects incident light into the output light, thereby producing a radiated light stream, or out of it, thereby attenuating the radiated light stream. To emit a color image, the light source comprises RGB color channels whose sequential switching, in cooperation with the controlled tilting of each DMD, produces a full color image in the light output stream.

Such a device is known from US 2003 218 794 which discloses a display device and a projector with a DMD module which is illuminated by sequentially turning the RGB light sourceson and off. If it is necessary to display the resulting white light, then the G channel must constitute 60 to 80% of the total luminous flux, so that the remaining R and B channels only constitute 20 to 40% of the total luminous flux. This distribution of the desired total luminous flux among the individual RGB channels must then correspond to the light power of the individual light sources for each channel of the RGB spectrum, with the desired luminous flux for the G channel being approximately twice as large as that of the R or B channel. To solve this problem, US 2003 218 794 proposes to use a pair of light sources to illuminate the DMD, wherein the first source comprises a B channel and R channel of the RGB spectrum which can have comparable light power, whereby the DMD device is at the same time irradiated with a second light source with G channel of the RGB spectrum, whereby the second radiation source of a single G channel has enhanced light power compared to the R channel or B channel, e.g., by using a plurality of monochromatic (G channel) LEDs as one radiation source. Thus, the second radiation source, comprising only a G channel of the total RGB spectrum, produces different radiation than the first radiation source comprising only the R-B radiation source of the total RGB spectrum. Thus, neither of the two radiation sources for DMD contains the “wavelength” of the radiation of the other light source, since the G-channel needs to be contained much more in the resulting radiation than the R and B channels.

When using a DMD in a vehicle lighting device as a headlamp, i.e. to illuminate the scene in front of the vehicle, it should be noted that the luminous efficiency of such a DMD depends on the luminous efficiency of the light sources and then by etendue limitation of the DMD. Thus, in order to achieve the required brightness in the automotive headlamp, the device must operate with 100% power, i.e. so that the DMD reflects 100% of the light from the light sources into the light output, i.e. the DMD is in the “on” status for 100% of the time, i.e., in the status with the micromirrors tilted to the position in which they reflect light from the light sources into the light output. In this case, however, there is a further limitation caused by high operating temperatures, namely the limitation in the form of a significant phenomenon of memory effect of motion hinges of the individual micromirrors, and also the problem of ing stiction, i.e. static friction, which must be overcome to set the micromirror in motion. Both of these problems then cause malfunction of the emitted light or even the malfunction of the DMD as such, which causes failures of the entire lighting device. This is a great problem for vehicles, because such a fault can only be remedied by replacing the DMD or by replacing the entire vehicle lighting device. To reduce the problems connected with the phenomenon of the memory effect of the motion hinges of the micromirrors and with raising stiction, duty cycling of the micromirrors is used, for example, i.e. their intentional tilting from the “on” state operating position to the “off” state operating position for a certain period of time, the so-called duty cycling, which, however, leads to a decrease in the brightness of the output light of the entire device, because a certain amount of light is dimmed in the device by being reflected to space outside the output of the lighting device.

A second option of solving the problem with the above-described memory effect and stiction is the solution according to US 2015 160 454 which discloses a DMD against which two identical light sources are arranged, whereby the two sources illuminate the active surface of the DMD, whereby the individual DMD mirrors being controlled such that, in their tilted position, they reflect the light from the first light source into the light output of the device and in their second tilted position they reflect the light from the second light source into the light output of the device. In order to avoid a decrease in the output brightness when changing the tilted position of the micromirrors, which would result in the flickering of the output light, part of the micromirrors is always tilted to the first position so as to reflect light radiation from the first source and part of the micromirrors is tilted to the second position so as to reflect light from the first source into the output. Optionally, another part of the micromirrors moves between these two positions. This reduces both the micromirrors hinge memory effect and stiction, which increases the service life and reliability of the DMD with only small or no reduction in the brightness of the output light of the vehicle's lighting device.

However, none of the documents mentioned does not allow the use of DMDs to simultaneously radiate sufficiently intense (bright) white light to illuminate the scene in front of the vehicle, and simultaneously to output supplement information with sufficient contrast and color in said stream of sufficiently bright white light, e.g., in order to warn or inform other surrounding persons or vehicles, to warn or inform the driver of the respective vehicle, etc.

The object of the invention is to eliminate or at least reduce the disadvantages of the background art.

### PRINCIPLE OF THE INVENTION

The object of the invention is achieved by a vehicle lighting device with a digital micromirror device, whose principle consists in that a first light source comprises at least one independently controllable white light source and a second light source comprises at least one independently controllable non-white light source, wherein the control device of the DMD is adapted to control the micromirrors of the DMD to project white light through an output element and simultaneously independently control part of the micromirrors of the DMD so as to independently project at least one non-white light pattern through the output element of the vehicle lighting device.

The advantage of this solution is the radiation of sufficiently intense (bright) white light to illuminate the scene in front of the vehicle, and at the same time to illuminate, with sufficient contrast and color, supplement information in the stream of sufficiently bright white light, e.g., to warn or inform other surrounding persons or vehicles, to warn or inform the driver of the respective vehicle, etc.

### DESCRIPTION OF DRAWINGS

The invention is schematically represented in the drawing, wherein

FIG. 1 shows a principle scheme of the invention,

FIG. 2 a functional scheme of an embodiment of the invention,

FIG. 3 is a plan view of an example of the use of the invention in road traffic; and

FIG. 3a is a side view of the exemplary embodiment of FIG. 3.

### DETAILED DESCRIPTION

The invention will be described as embodied in exemplary embodiments of a vehicle lighting device which is intended especially to illuminate the scene in front of the vehicle.

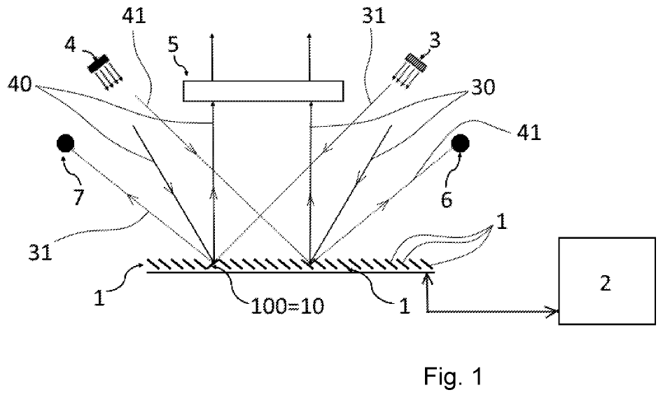

As shown in FIG. 1, the vehicle lighting device comprises a digital micromirror device (DMD) 1, which is connected to a control device 2. The DMD 1 consists of an array of micromirrors 10. At least one source 3 of white light and at least one source 4 of non-white light is directed against the array of micromirrors 10. In the embodiment shown, the sources 3, 4 of both types of light are arranged obliquely opposite the array of micromirrors 10 on both sides of the DMD 1. An output element 5 of the light from the lighting device is arranged opposite the array of micromirrors 10 in the central axis of the DMD 1. The light from each of the light sources 3, 4 of both types of light falls on the array of micromirrors 10 at a specified angle, whereby depending on the actual tilted position of each micromirror 10, it is either reflected in a controlled manner into the light output element 5 as the output light 30, 40 or is reflected outside the light output element 5 as non-output light 31, 41, e.g., to a respective absorber 6, 7 of light, or the light is absorbed by the structure of the DMD 1, etc.

The white light source 3 comprises at least one LED or laser diode with white output light or comprises another suitable “white” light source.

The non-white light source 4 comprises at least one non-white LED or laser diode or another suitable source of “non-white” light, including an RGB non-white light source, e.g. an RGB LED or an RGB laser diode with separately controllable RGB channels, etc.

According to one embodiment, the control device 2 of the DMD 1 is adapted to control both light sources 3, 4. In another embodiment, each light source 3, 4 is connected to a different control device which is coordinated with the control device 2 of the DMD 1.

The inclination of each mirror 10 into a respective position in which each individual mirror 10 is “on” or “off” independently of the other mirrors 10 to reflect the light from the respective light source 3, 4 into the light output element 5 is controlled by the control device 2.

As shown in FIG. 1, one particular mirror 100=10 is in the “on” state operating position position for non-white light from a non-white light source 4 (this particular mirror 100=10 reflects non-white light into the light output element 5), and simultaneously, this particular mirror 100=10 is in the “off” state operating position for white light from the white light source 3 (this particular mirror 100=10 does not reflect white light into the light output element 5). Nevertheless, at the same time, the other mirrors 10 are in the “on” position for white light from the white light source 3 (these other mirrors 100=10 reflect white light into the light output element 5) and the above-mentioned particular mirror 100=10 is in the “off” position for non-white light from the non-white light source 4 (this particular mirror 100=10 does not reflect non-white light into the light output element 5). As a result, in the light output element 5 there is one pixel in cross section (caused by reflection of the light from the non-white light source 4 from the above-mentioned single particular mirror 100=10 set in the “on” position for non-white light from the source 4) and the other pixels are white because they reflect white light from the white light source 3. In this manner, i.e. by controlling the inclination of certain mirrors 10 to the “on” position for the non-white light from the source 4, it is thus relatively easy to “insert” color-different information, even of a more complex character, into the continuous white light output from the white light source 3, in the color of non-white light from the non-white light source 4, without substantially reducing the brightness, or luminous flux, of the white light for the illumination of the space in front of the vehicle.

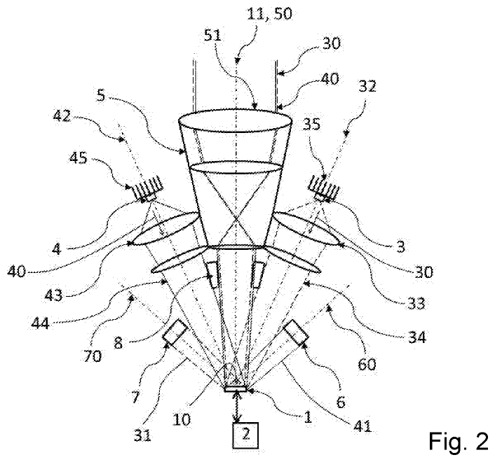

In the embodiment shown in FIG. 2, the vehicle lighting device comprises a digital micromirror device (DMD) 1 which is connected to a control device 2. The DMD 1 comprises an array of micromirrors 10. At least one white light source 3 with an optical illumination axis 32 and at least one non-white light source 4 with an optical illumination axis 42 are directed against the array of micromirrors 10. To reduce the influence of heat, the light sources 3, 4 of the two types of light are, for example, arranged on coolers 35, 45. The light sources 3, 4 of the two types of light are arranged obliquely against the array of micromirrors 10 on both sides of the DMD 1, with illuminating optics, here specifically illuminating optics 33, 34 for white light being arranged in the path of the white light on the DMD 1 and illuminating optics 43, 44 for non-white light being arranged in the path of non-white light on DMD 1. Opposite the micromirror array 10 is in the central axis 11 of the DMD 1, which is at the same time the central axis 50 of the light output element 5, disposed a light output element 5 of the light device. In this particular embodiment, the light output element 5 is formed by an imaging optics with an output lens 51. The light from each of the light sources 3, 4 of the two types of light falls on the array of micromirrors 10 at a determined angle, whereby, depending on the actual tilted position of each the micromirror 10, it is either reflected in a controlled manner into the light output element 5 as output white light 30 or output non-white light 40 or the white or non-white light is reflected outside the light output element 5 as a non-output white light 31 and a non-output non-white light 41, e.g. into the respective light absorber 6, 7 with optical axes 60, 70, or the light is absorbed by the structure of the DMD 1 etc. In the embodiment shown, to improve the light parameters, the input of light reflected from the DMD 1 into the light output element 5 is shielded from the white and non-white light streams transmitted to the DMD 1 from white and non-white light sources 3, 4, e.g., an aperture 8 in the form of a centric ring is placed in front of the light entry into the light output element 5.

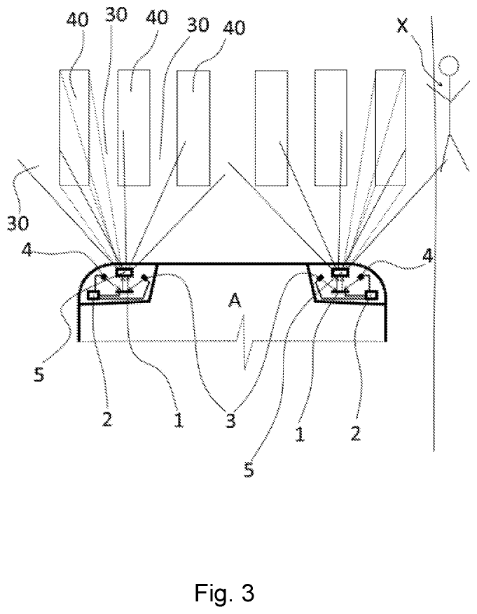

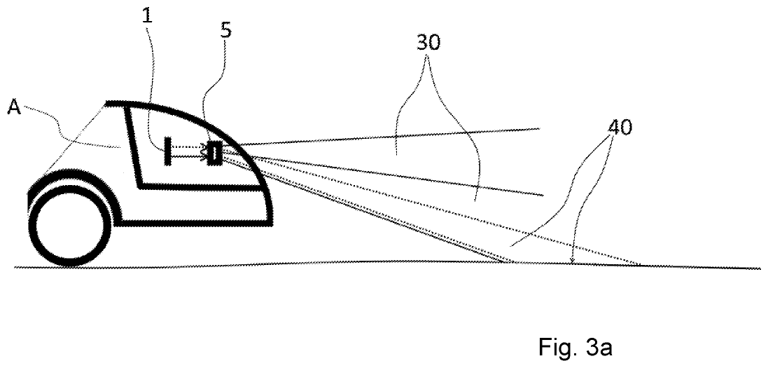

FIGS. 3 and 3a show an example of using of the invention to increase traffic safety, when after stopping the vehicle in front of a pedestrian X standing at the side of the roadway, the lighting device according to the invention projects a colored “zebra crossing” symbol on the roadway created by non-white output light 40, while the space in front of the vehicle is illuminated enough by the white output light 30, so the pedestrian reliably knows that he can safely cross the road.

However, the exemplary embodiment shown in FIGS. 3 and 3a is not limiting for the use of the invention, since the invention allows to project virtually any, and for distinguishing from the basic illumination of the space in front of the vehicle, non-white image in front of the vehicle lighting device not only on the roadway, but also into space, on a wall, etc., always maintaining sufficient illumination of this space with the output white light 30.

1. A vehicle lighting device comprising a digital micromirror device (DMD) connected to a control device, wherein at least two light sources with differently colored output lights are directed to the active reflective surface of the DMD formed by micromirrors and in front of the active reflective surface of the DMD an output element of the vehicle lighting device is situated, wherein the control device of the DMD is adapted to independently control the position of the individual micromirrors of the DMD, wherein the first light source comprises at least one independently controllable white light source and the second light source comprises at least one independently controllable non-white light source, wherein the DMD control device is adapted to control the micromirrors of the DMD to project white light through the output element and simultaneously independently control part of the micromirrors of the DMD to independently project at least one non-white light pattern through the output element of the vehicle lighting device.

2. The vehicle lighting device according to claim 1, wherein the white light source comprises at least one LED or laser diode with white output light, and the non-white light source comprises at least one non-white LED or non-white laser diode.

3. The vehicle lighting device according to claim 1, wherein the control device of the DMD is adapted to control the two light sources.

4. The vehicle lighting device according to claim 1, wherein between the white light source and the DMD is in the first optical axis arranged first illuminating optics and between the non-white light source and the DMD is in the second optical axis arranged second illuminating optics.

5. The vehicle lighting device according to claim 1, wherein on the sides of the DMD are provided light absorbers.

6. The vehicle lighting device according to claim 1, wherein between the DMD and the output element is in the front of the output element arranged an aperture.
